(19) United States
(12) Patent Application Publication
(10) Pub. No.: US 2005/0021258 A1
(43) Pub. Date: Jan. 27, 2005

(54) Display color calibration system

(76) Inventor: Peter Fasciano, Framingham, MA (US)

Correspondence Address: PETER J. GORDON, PATENT COUNSEL, AVID TECHNOLOGY, INC., ONE PARK WEST, TEWKSBURY, MA, 01876, US

(21) Appl. No.: 10/897,288

(22) Filed: Jul. 22, 2004

Related U.S. Application Data
(60) Provisional application No. 60/489,375, filed on Jul. 23, 2003.

(51) Int. Cl. H04N 17/00; G06F 19/00

(52) U.S. Cl. 702/67; 348/184

(57) ABSTRACT

A display color calibration system uses a spectrophotometer or other sensor connect to a computer along with a computer program running on the computer to provide a mechanism to calibrate and standardize the color performance of display devices used by video applications. Such display devices include both computer displays connected to the computer and video displays connected to the computer. In particular, test colors are presented as an ordered set of samples controlled by the computer program and are presented via a video application to the display devices. The video application may be, for example, software for a digital nonlinear video editing system (NLE) or any other video playback engine on the computer. Once calibrated, these display devices can present a gamut of colors as a standard color space. This calibration improves the display accuracy and consistency for critical viewing and color evaluation of images.

### CROSS REFERENCE TO RELATED APPLICATION

This application is a nonprovisional application that claims the benefit of provisional application Ser. No. 60/489,375, filed Jul. 23, 2003, and hereby incorporated by reference.

### BACKGROUND

In the editing and finishing of motion pictures, it is common for an editing or finishing system, such as a digital nonlinear editing system (NLE), to include a calibrated reference color video monitor (often called a “client monitor”) on which motion video is played back. A purpose of the client monitor is to provide an output on which the colors are deemed to be accurate, thus permitting a client to have an accurate view of the video being edited.

As editing and finishing systems are becoming more computer-based, more computer monitors are being used. Some systems may have more than one display on which video may be displayed. Some systems may not have a client monitor. The proliferation of different displays increases the need for a process or apparatus for ensuring that an accurate color display is provided.

### SUMMARY

A display color calibration system uses a spectrophotometer or other sensor connect to a computer along with a computer program running on the computer to provide a mechanism to calibrate and standardize the color performance of display devices used by video applications. Such display devices include both computer displays connected to the computer and video displays connected to the computer. In particular, test colors are presented as an ordered set of samples controlled by the computer program and are presented via a video application to the display devices. The video application may be, for example, software for a digital nonlinear video editing system (NLE) or any other video playback engine on the computer. Once calibrated, these display devices can present a gamut of colors as a standard color space. This calibration improves the display accuracy and consistency for critical viewing and color evaluation of images.

### BRIEF DESCRIPTION OF THE DRAWINGS

FIG. 1 illustrates color samples that may be displayed on a color video picture monitor (CPM).

FIG. 2 illustrates an example user interface for inputting values.

FIG. 3 illustrates an example user interface for inputting values.

FIG. 4 illustrates an example user interface for inputting values.

FIG. 5 illustrates an example input signal for use in calibration.

FIG. 6 illustrates an example of how controls may affect the red and blue channels.

FIG. 7 illustrates how test colors may be represented in a time-ordered composition.

FIG. 8 illustrates an example user interface for inputting values.

FIG. 9 illustrates an example user interface for inputting values.

FIG. 10 illustrates an example flow through the user interface for calibration.

FIG. 11 illustrates an example flow through the user interface for calibration for a master color monitor.

FIG. 12 illustrates an example flow through the user interface for calibration for other video monitors.

FIG. 13 illustrates an example flow through the user interface for calibration for a CPU display.

FIG. 14 illustrates an example flow through the user interface for calibration for a CPU display using a graphics card.

FIG. 15 illustrates an example flow through the user interface for calibration for a CPU display using a video overlay.

FIG. 16 illustrates an example flow through the user interface for calibration for ambient lighting.

FIG. 17 illustrates an example flow through the user interface for calibration using a learn/teach method

FIG. 18 illustrates an example flow through the user interface for calibration using a learn/teach method.

FIG. 19 is a block diagram of an example system.

### DESCRIPTION

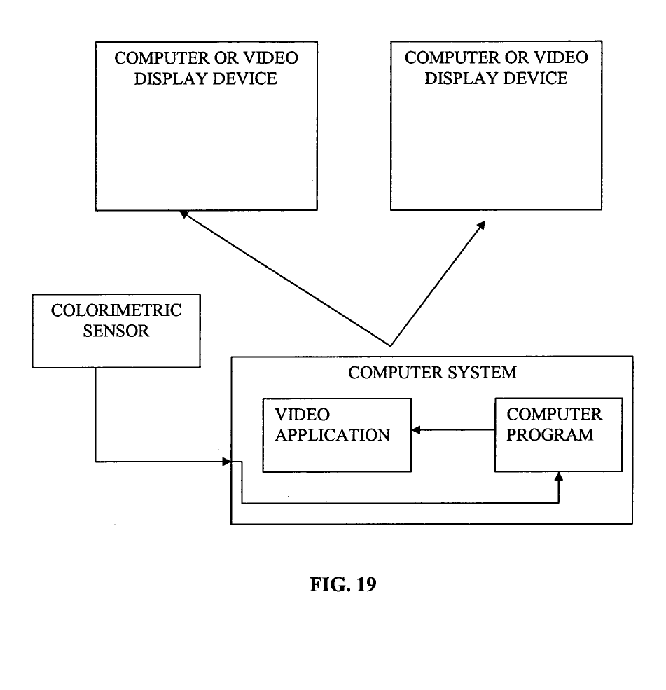

Referring now to FIG. 19, a display color calibration system 1900 uses a spectrophotometer 1902, such as the Monaco Optix Sensor device connected to a computer via a USB port, along with a computer program 1904 running on a computer 1906 to provide a mechanism to calibrate and standardize the color performance of display devices, including a first display 1908 (such as a computer display) connected to the computer 1906 and a second display 1910 (such as a video display) connected to the computer. In particular, test colors are presented as an ordered set of samples controlled by the computer program 1904 and are presented via a video application 1912 to the display devices. The video application may be, for example, software for a digital nonlinear video editing system (NLE) or any other video playback engine on the computer. Thus, calibration is performed on the display devices using image data that passes through the video signal color gamut or video signal domain. Once calibrated, these display devices can present a gamut of colors as a standard color space. This calibration improves the display accuracy and consistency for critical viewing and color evaluation of images.

This system may be used, for example, with desktop class computing systems that support video signal recording, playback, editing and similar tasks. Still graphics are often included as elements in video sequence compositions. It is assumed that any color space conversions are performed on these graphic elements directly when they are imported into an NLE. Thus, color display calibration performed for video viewing is deemed also correct for those still graphic elements incorporated into a video program.

The software 1904 and sensor 1902 enable a user to properly calibrate all visual display devices, both the computer display(s), and any attached client video monitor(s) for standardized critical viewing and color evaluation of video clips and sequences.

There are several types of data and signal displays incorporated into the typical video post-production environment. These are signified as signal destinations in standard facility wiring schematic diagrams according to the following display naming conventions:

| | |
|---|---|
| Color Computer Data Monitor | CDM |
| Color Video Picture Monitor | CPM |
| Monochrome Video Picture Monitor | PXM |
| Video Level Waveform Monitor | WFM |
| Color Video Vector Scope Monitor | VSM |

The general goal is to measure and calibrate the color rendering performance of all display devices to provide a consistent, standardized critical viewing environment suitable for determining and making accurate color correction adjustments to video media clips and sequences. This color performance and environment is prescribed in SMPTE recommended practices RP601 and RP704 for color gamut and RP166 for the viewing environment.

Subjective display devices that may be calibrated using this system:

| | |
|---|---|
| Color Video Picture Monitor | CPM |
| Monochrome Video Picture Monitor | PXM |
| Color Computer Data Monitor | CDM |

Objective display and signal measurement devices that are self-calibrated internally:

| | |
|---|---|
| Video Level Waveform Monitor | WFM |
| Color Video Vector Scope Monitor | VSM |

Some video applications may represent the WFM and VSM as virtual displays on the CDM. As such, there is no specific color calibration required for these presentations.

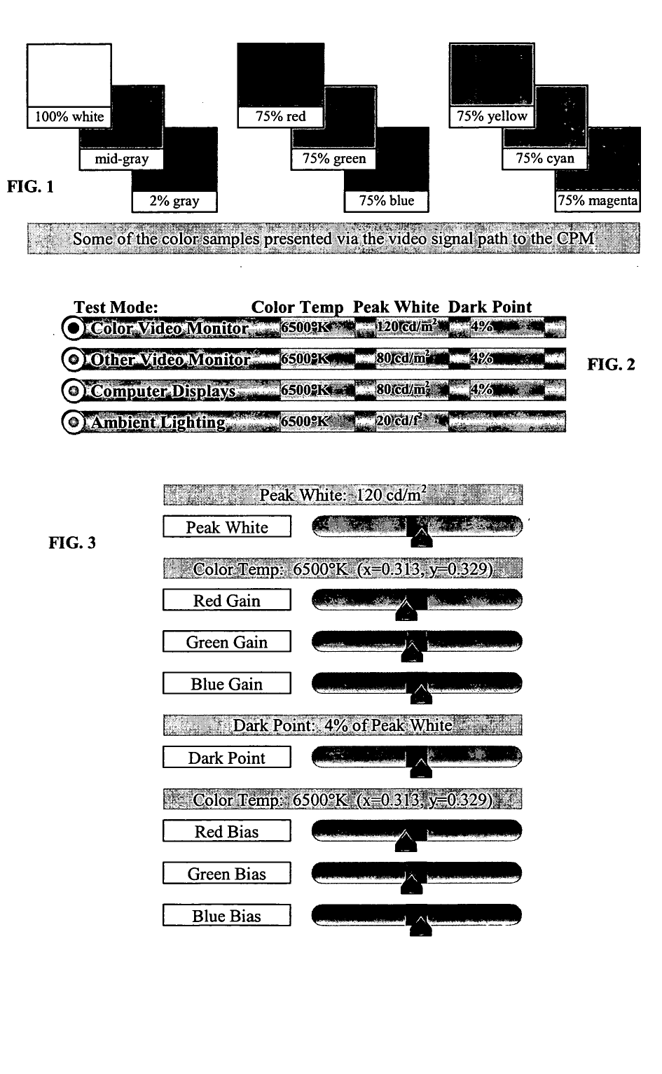

The computer program 1904 operates the sensor 1902, which is affixed to the screen of the display device under test. The sensor is positioned on the given display screen surface to detect light from a small sampling area. This area presents a uniform sampling field of known digital values for white, black, gray, a range of colors, etc., such as shown in FIG. 1. These test colors are presented as an ordered set of samples controlled by the computer program 1904 and are presented via the video application 1912 to the CDM. During the calibration procedures of the CPM and other external monitor(s) these sample colors are also presented via the video application 1912 as a normal video signal directly to the CPM.

For illustrative purposes, when specific colors are called out these are described in the form of their RGB primary values.

When the video application 1912 displays a still frame of a video image on a CDM the frozen image may flow through the normal graphics data path to the display. The video frame is converted to an RGB form that is compatible with the CDM display format. When the video application 1912 displays full motion video on a CDM the image may flow through a separate overlay path to the display. The video stream is converted to an RGB form that is compatible with the CDM display format. The color gamut for both the Background Graphics path and the Video Overlay path may be determined by a separate, programmable LUT for each signal path. Graphics subsystem designs may vary, but for purposes of this document it is assumed that separate graphics LUTs are implemented.

The processing of video data via either display path may vary across different video applications. Some analog video signals (NTSC, U.S.) require a black setup of 7.5 IRE units and not 0 IRE units at specific transport stages. Digital component video does not utilize a setup value. Not all video and NLE applications are consistent in the treatment of internal digital video black level and other parameters. Some applications display video as ranged between digital values of 16 to 235. This is consistent with the SMPTE RP-601 digital video signal specification. Some applications display video as ranged between digital values of 0 to 255. This is consistent with normal RGB graphics images.

Thus, the calibration system incorporates the NLE or other video processing application's image processing into the calibration procedure by passing the color samples as still and video images via the NLE application normal paths and processes to the display. The computer program 1904 therefore operates in conjunction with the NLE application to coordinate the presentation of color samples in an order that properly calibrates the display. The sensor is centered over the NLE video window on a computer display.

The general color environment calibration goal is addressed through the completion of a number of specific device calibration goals. The methods for meeting these goals are applied to all devices of the following display types: the CPM, the PXM, the CDM, and to the ambient room lighting respectively. These goals may be addressed independently in any order as the performance of each has no direct bearing on outcomes of the others. However, calibrating the CPM first provides a visual reference for the CDM results. One or more calibration methods are described for achieving each of these specific goals.

Referring now to FIGS. 2-18 an example user interface for the computer program 1904 will now be described, and will structure a description of the various functions of the computer program 1904.

On a so-called “Home Page” for the system the values for color balance, peak white and dark point illuminance may be either manually entered by values or selected from a menu/picker, such as shown in FIG. 2. Optionally, whenever the application shows a display calibration page the target values for the given display may be input there as well.

Video images exist in a variety of signal forms as presented to the different display types. The CDM(s) are connected to the host computer graphics subsystem and receive video in the form of three RGB channel signals.

The CPM(s) are connected typically to either the primary video output or if available, to a separate monitor video output. Analog video connection may be supported in the form of: a one-wire composite NTSC or PAL signal, a two-wire Y/C video signal, or a three-wire Y:Cr:Cb component video signal. Digital video is a one-wire serialized data form of the three-wire Y:Cr:Cb video signal.

Calibration procedures are prescribed specifically for each of the display types, and further prescribed where necessary for displays connected via specific video signal types.

Unless otherwise indicated, when calibrating the CDM the sensor is positioned in the center of the video application's normal video window. When calibrating the CPM or other external video display devices, the sensor is positioned over the center of the external display screen.

Manual adjustments are made to the CPM according to guided steps presented through the CDM UI. The UI also provides a visual feedback loop for all sampling and adjustment results. The various steps described throughout the calibration procedure are noted as manual or automatic or directed. Some examples include:
Manual adjustment of controls on the display device being calibrated.
Automatic generation of a color LUT or DDC/CI control adjustment.
Manual cycling/reading of color samples through a video application.
Directed cycling/reading of color samples through a video application.

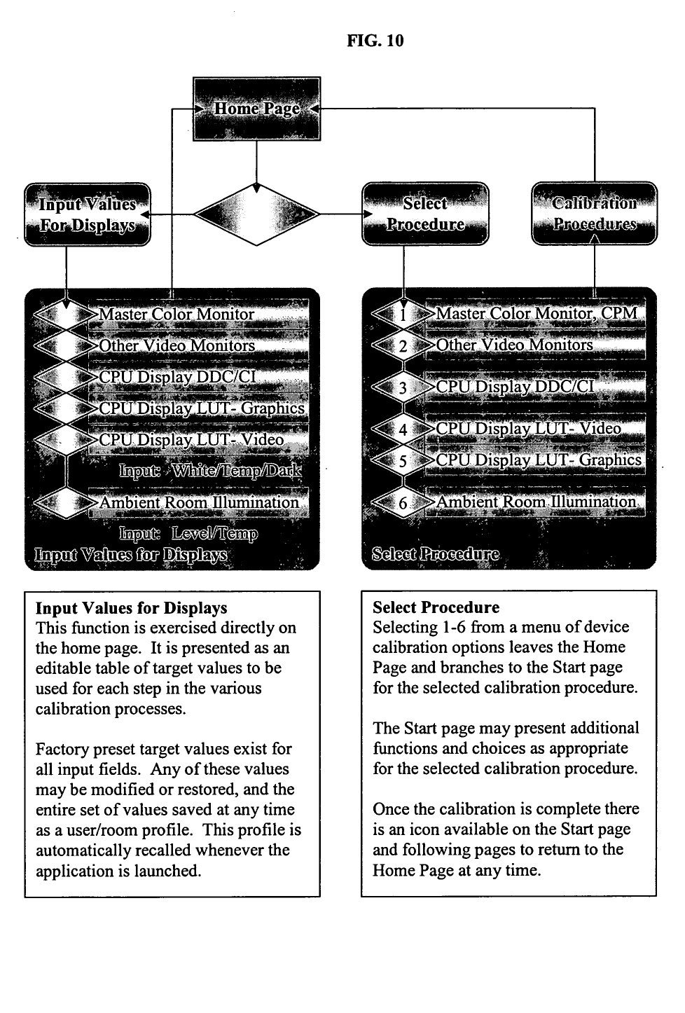

As shown in FIG. 10, the user interface may have a home page from which these steps and methods are accessed.

Some specific calibration goals and methods for the CPM will now be described. Color Picture Monitors (CPM) are designed to support a tightly prescribed color gamut. This gamut is defined by SMPTE RP-601 for standard definition video and by RP-704 for high-definition video. SMPTE compliant CPM's are specified by grades A, B, or C to cover a range of performance tolerances. They are designed and internally adjusted to comply with SMPTE color performance specifications by degree according to their respective grades. These gamut specifications are largely determined by the CRT display's RGB phosphors and by the internal color decoding matrix circuits for composite analog video or Y:Cr:Cb component analog or digital video signals. The overall calibration goal for the CPM is to optimize its color rendition to comply with the SMPTE standards.

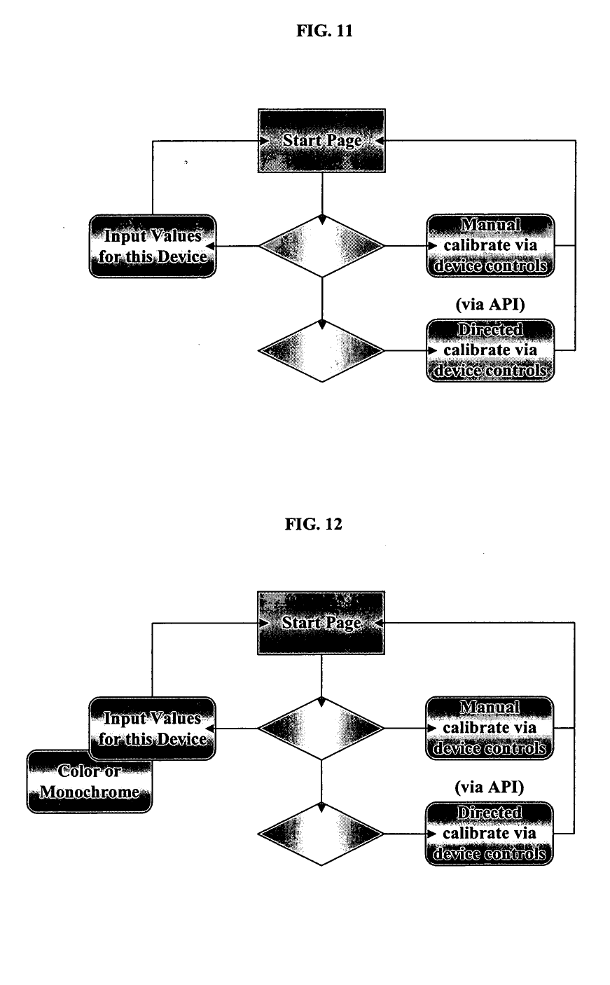

The application, as described by the flowchart of FIG. 11, provides the ability to:
a. Set and recall a default target value for illuminant color temperature and white output.
b. Provide UI visual feedback as to the detected optical output value for peak white.
c. Provide UI visual feedback as to the detected illuminant in degrees Kelvin or Mireds.
d. Provide UI visual feedback on RGB settings to balance color temperature across a grayscale.

For Y:Cr:Cb component video signals the application provides the ability to:
a. Calibrate CPM(s) brightness and contrast settings for optimal black and white levels.
b. Calibrate CPM(s) to reasonably match a D65 illuminant color temperature per SMPTE RP-166.
c. CPM(s) matrix and phoshors are assumed to support SMPTE RP601 or 704 color gamut.
d. Calibrate the CPM chroma gain to achieve the proper degree of color saturation.

For composite NTSC video signals only, where a color hue setting is operative, the application provides the ability to calibrate the CPM color phase/hue/tint setting to achieve the proper color phase.

A manual adjustment method for calibrating a CPM is the following. Manual controls as available in the CPM display are adjusted by the user based on visual feedback of display error information provided via the user interface. Manual calibration may be performed for adjusting the display color temperature via the RGB level controls for bias and gain. Master brightness and contrast may also be calibrated manually, but the color gamut is preset by the CPM color matrix and phosphors.

The CPM calibration process does not operate directly on, or affect the output video signal in any way.

A manual, step-by-step procedure for calibrating the CPM contrast & brightness involves the follow steps:
a. Set a target peak white value (typ. 30 ftL) to be achieved through calibration.
b. Reduce the CPM chroma gain or color saturation control to the minimum setting.
c. If the CPM has a “Monochrome” mode, this mode may be used to turn chroma off.
d. Place the color sample for white on the video signal output to the CPM.
e. Adjust “Contrast” to center the UI white reading.
f. Place the color sample for 2% gray on the video signal output to the CPM.
g. Adjust “Brightness” to center the UI dark reading.
h. Repeat the above procedures until both conditions are optimal.

A manual, step-by-step procedure for calibrating the CPM color temp/grayscale tracking is the following:
a. Set a target color temperature (typ. D65/154M) to be achieved through calibration.
b. Locate the CPM's RGB channel bias and gain adjustments.
c. Place the color sample for white on the video signal output to the CPM.
d. Adjust RGB Gain controls to center the UI white readings.
e. Place the color sample for 2% gray on the video signal output to the CPM.
f. Adjust RGB Bias controls to center the UI dark readings.
g. Repeat the above procedures until both conditions are optimal.

A manual, step-by-step procedure for calibrating the CPM chroma gain/saturation is the following:
a. Locate the chroma gain/saturation control.
b. Place the sample for 75% White on the video signal output to the CPM.
c. Allow the sensor to sample and store a value for White.
d. Place the sample for 75% Blue on the video signal output to the CPM.
e. Adjust “Chroma Gain” to center the UI color reading.
f. Repeat the above procedures until all conditions are optimal. Note that this function may also be satisfied with the Magenta sample. (see below)

A manual, step-by-step procedure for calibrating the CPM color phase/hue is the following:
a. Locate the color phase/hue control.
b. Place the sample for 75% Magenta on the video signal output to the CPM.
c. Adjust “Color Phase” to center the UI phase reading.
d. Repeat the above procedures until all conditions are optimal.

In the above procedure any one of the color samples for R, G, or B should suffice for calibrating chroma saturation, and the other two samples should read as very close. The Y, C, or M color samples for setting phase/hue likewise should all be very close. Note that of all the color samples the one that will likely be most effective overall for setting both Chroma Gain and Phase is the 75% Magenta sample. Thus, an abbreviated manual adjustment procedure using only the Magenta sample could be developed to calibrate both Chroma Gain and Phase simultaneously via two UI feedback loop readings.

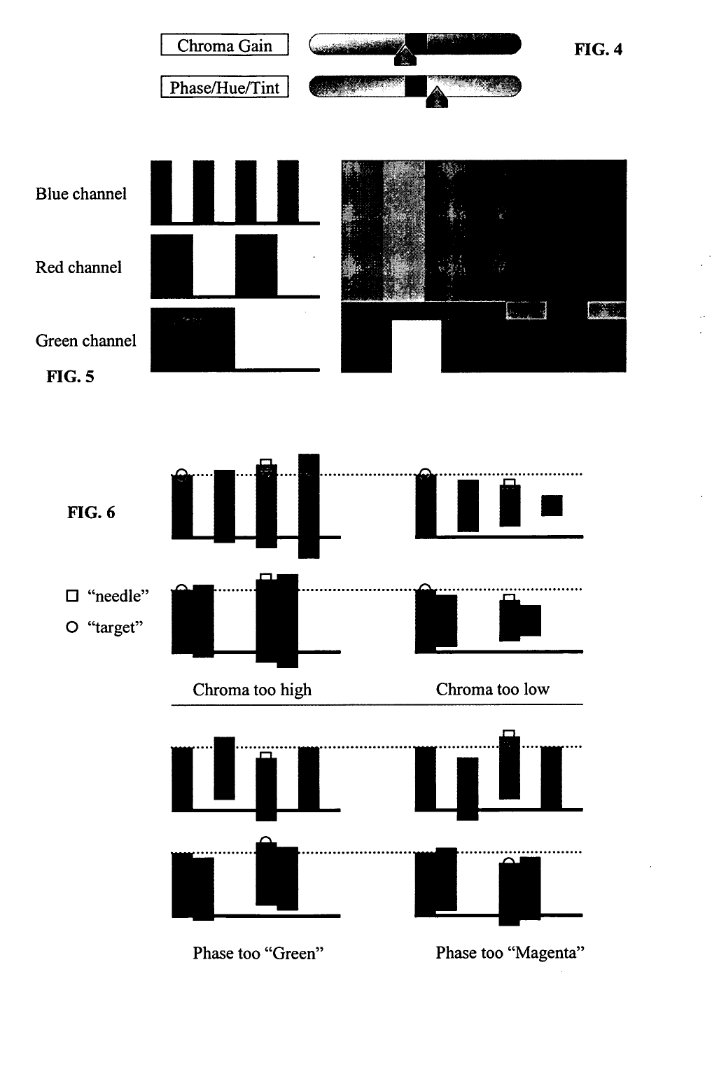

The functional detail of the primary video CPM user interface will now be described. FIG. 3 illustrates how six feedback setpoints for RGB white and dark settings may be presented for operator interaction. Additionally, for NTSC composite video two bar graphs for Chroma & Hue may be generated to provide visual feedback in the calibration procedure, as shown in FIG. 4. The Chroma graph plots the signal ratio of Chroma (averaged R&B) to Luminance (Y). The Phase/Hue graph plots the signal ratio of R to B. In both cases the goal is to adjust the ratios (bar graph readings) to a setting of unity.

The video signal is synchronously switched between a peak white center square in a black surround field and a very dark center square in a lighter surround. Both sample frames will have the same APL (average picture level) of 50% to facilitate a stable switch between these images with minimal image DC bounce. The sensor will be strobed to read dark or white RGB values as appropriate to the displayed sample frame.

The dark color temperature is adjusted by aligning the CPM RGB minimum brightness levels or screen/bias settings. The white color temp is adjusted with the RGB channel gains. When all indicators are aligned to their respective targets the CPM should provide proper grayscale tracking for the target color temperature from black to the desired target peak white illuminance.

Some CPM models may exhibit interactions of certain adjustments. Any interaction between adjustments will be readily apparent during the calibration procedure. The ordering of CPM adjustments that minimizes any interaction is: Brightness, Contrast, Chroma Gain, Phase.

FIG. 5 illustrates a sample signal to be used for calibration.

FIG. 6 illustrates how the Blue and Red channels above are affected by the Chroma & Phase controls. In all cases the R or B bar representing 75% White (leftmost) never changes with adjustments to Chroma or Phase. Chroma Gain is measured within R and/or B, comparing the left point (white) to right (color). Phase compares the R to B color components of Magenta for a level match.

The Dark and White samples are used for setting overall Brightness/Contrast and RGB Color Temperature. The Magenta sample (needle) is matched to the White sample (center target) for adjusting Chroma Gain. The R and B components of a Magenta sample (eg: R as needle & B as target) are matched to set Phase/Hue/Tint.

The minimum order of test colors shown in FIG. 7 supports all necessary measurements for proper CPM calibration. Sample 1 and 2 are used for brightness/contrast settings and for grayscale RGB balance. Samples 2 and 3 are compared for calibrating Chroma Gain/Saturation, and Sample 4 R&B are compared for calibrating Color Phase/Hue/Tint.

For the client CPM the following steps are performed:
a. Set a target color temperature (typ. D65/154M) to be achieved through calibration.
b. Generate RGB bar graphs for visual feedback in the calibration procedure.

These bar graphs will be presented for RGB bias (black) and RGB gain (white). These will be updated continually and automatically while monitor is adjusted manually. Black RGB bar graphs will detect a minimal illumination value of 1-3 footLamberts. White RGB bar graphs may be preset to a target light output of 15-40 footLamberts. Multiple readings may be averaged if necessary to improve detector sensitivity.

The samples shown in FIG. 7 may be represented by a composition in a nonlinear editing system, such as the Avid Media Composer. The NLE permits directed sampling control via an API. The sampling and display update may be continuous and directed via an API, allowing the operator to interact with the graphic display until the values are properly aligned. Commands to the calibration software, e.g., “read probe,” may be directed along an NLE timeline via an API. The NLE system will play a continually repeating cycle of appropriate target video colors synchronized along the NLE timeline as directed through the API. The NLE monitor output video signal is connected to the CPM to be adjusted. The UI continually updates the results of manual adjustments to the CPM as they are made.

Calibration of other video monitors, such as a monochrome PXM, also may be performed, as shown in FIG. 12. Specific calibration goals and methods for a monochrome PXM will now be described. In one method the system may:
a. Provide UI feedback for color temp values and manual brightness/contrast calibration.
b. Read and calibrate the brightness/contrast range of a monochrome PXM.
c. Read the effective color temperature of monochrome PXM phosphors.
c. Sample & display color temperature in both Kelvin & Mired values as offset errors.

Manual adjustment method for calibrating a PXM may involve using manual controls as available in the PXM display that are adjusted by the user based on visual feedback of display error information provided via the user interface. Brightness and contrast are calibrated manually. Trimming the color temperature of a monochrome PXM may be accomplished via lighting CT-O and CT-B series trim gels commonly used for color temperature correction in photography.

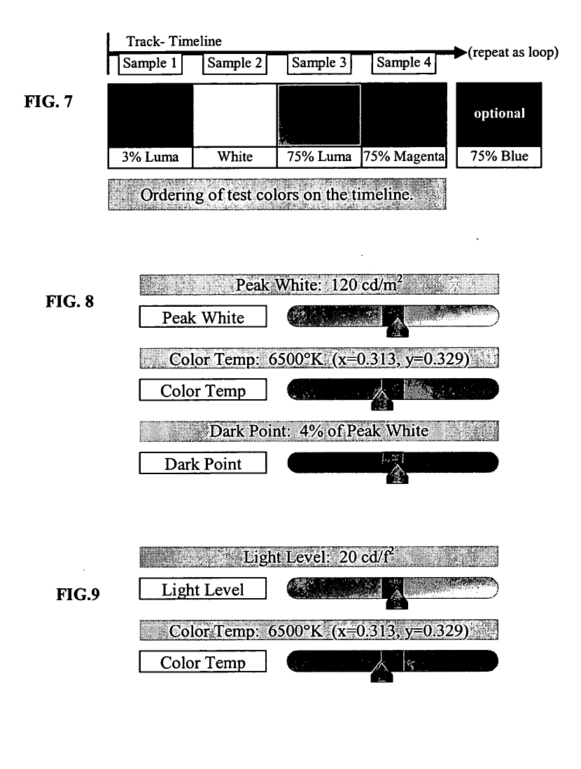

Monochrome PXM monitor calibration is done through a subset of the UI functions available for calibrating the CPM as shown in FIG. 8. The software provides a set of “secondary” monitor presets for this purpose. Optionally, these presets might also accommodate a second CPM with a “Color Reading On/Off” mode. The sensor is positioned to read monochrome monitor values in the normal manner by placing the sensor directly on the CRT surface.

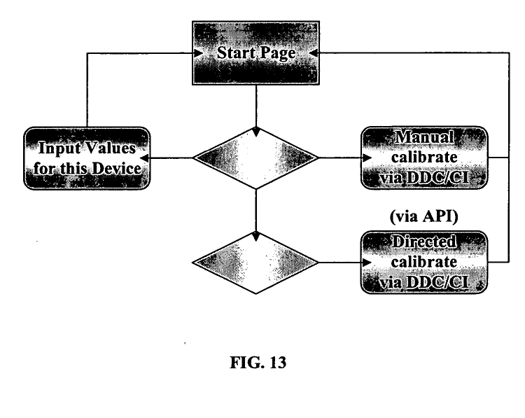

Specific calibration goals and methods for the CDM will now be described. The user interface and flow for these methods are shown in FIGS. 13-15. Computer displays (CDM) operate using a variety of display technologies, and with that variety, a range of color gamut renditions. The overall calibration goal for this type of display is to adjust its color rendition to visually match that of the CPM. The application provides the ability to:
a. Set and recall a default target value for illuminant color temperature and white output.
b. Provide UI visual feedback as to the detected optical output value for peak white.
c. Provide UI visual feedback as to the detected illuminant in degrees Kelvin or Mireds.
d. Provide UI visual feedback on RGB settings to balance color temperature across a grayscale.
e. Calibrate CDM(s) brightness and contrast settings for optimal black and white levels.
f. Calibrate CDM(s) to display a color neutral grayscale at a preset color temperature.
g. Calibrate CDM(s) to reasonably match a D65 illuminant color temperature per SMPTE RP-166.
h. Calibrate CDM(s) to reasonably match a SMPTE RP-601 or RP-704 video color gamut.
i. Optionally: Calibrate (Teach) CDM(s) to reasonably match the CPM video color gamut.

Manual adjustment method for calibrating a CDM involves using manual controls as available in the CDM display that are adjusted by the user based on visual feedback of display error information provided via the user interface. Manual calibration may be performed for adjusting the display color temperature via the device's RGB level controls for bias/gain and/or color temperature presets. Master brightness and contrast may also be calibrated manually, but not the display color gamut.

The software operates the sensor to analyze a display area that presents a uniform field of a known digital value for white, black, gray, a range of colors, etc. These sample colors are presented via the software directly to the CDM. The CDM UI provides visual feedback on CDM calibration results. The operation of the sensor and presentation and analysis of color samples are performed by the software in much the same manner as calibration for displays used in prepress graphics applications. The CDM color calibration process does not affect the output video signal.

An automatic method for calibrating a CDM with DDC/CI support, as shown in FIG. 13 provides brightness, contrast, color temperature and gamut calibration commands as supported by the given make/model/feature set of CDM directly from the application through the display's DDC/CI connection.

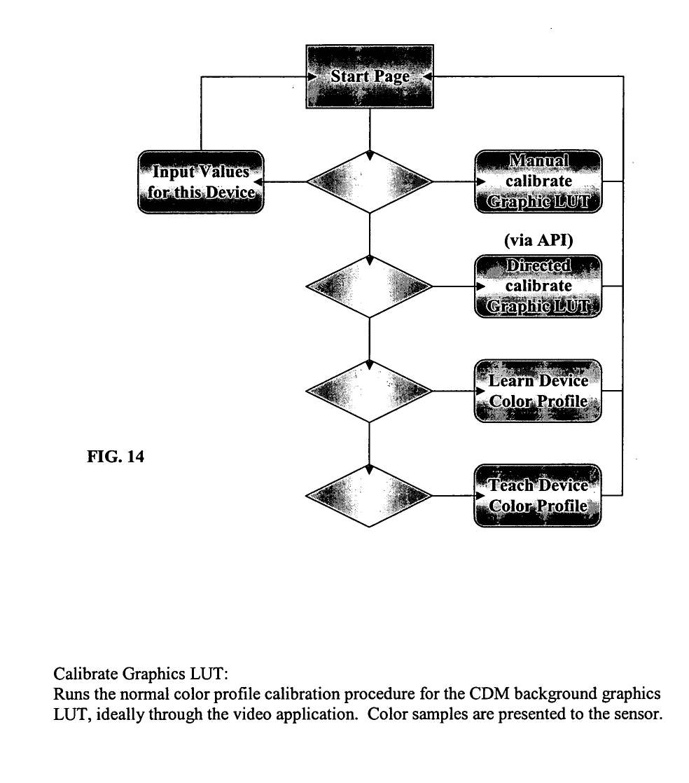

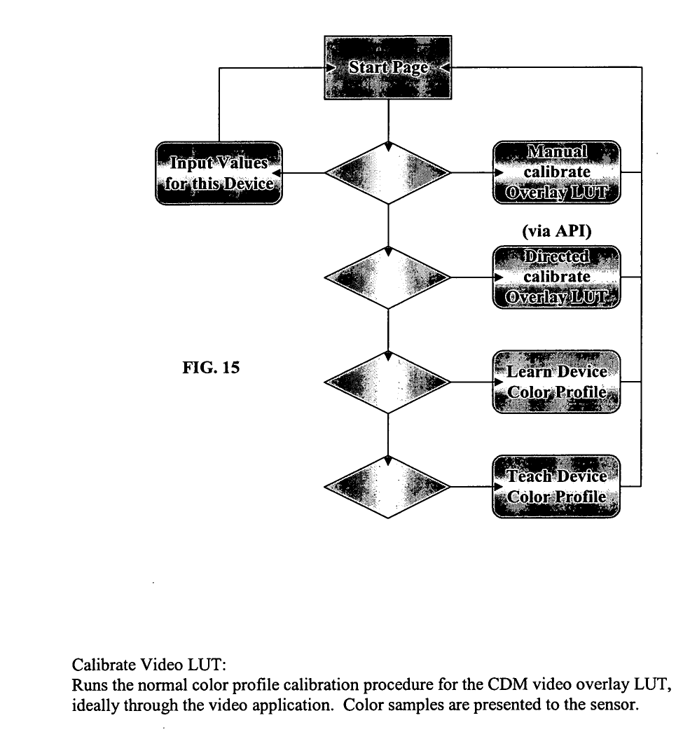

An automatic method for calibrating a CDM via the graphics card LUT is shown in FIG. 14, and involves generating a color look up table (LUT) as necessary to display a color neutral grayscale calibrated to a preset color temperature and to display a range of colors scaled/calibrated to achieve an RP-601 or RP-704 gamut. The color LUT is programmed for the host graphics card in the customary manner. A similar process is used for the video overlay LUT as shown in FIG. 15.

Calibration procedures are used to align the various displays as a critical viewing system. As such, the most important effect is to establish a uniform viewing experience across all displays by adjusting the CDM(s) to emulate the CPM color gamut as closely as possible.

To that end the user may serially employ any combination of the preceding strategies to achieve the desired results. The CDM display may be first proximally calibrated manually and then more precise calibration may be achieved using DDC/CI and finally, by programming the graphics card display LUT.

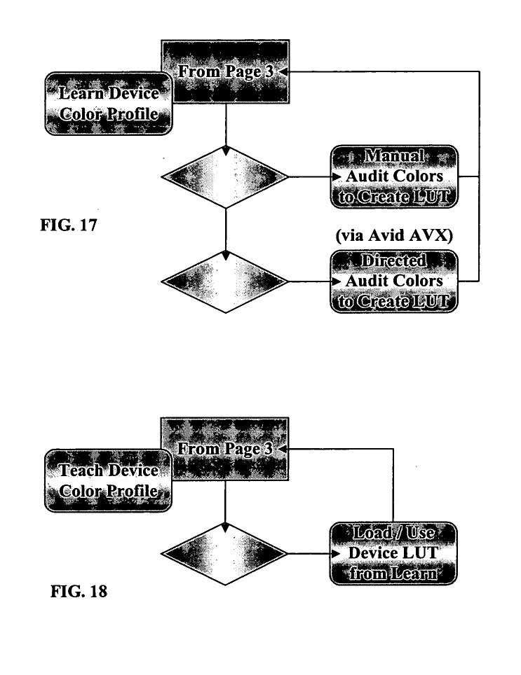

Additionally a Learn/Teach function for LUT creation is available as shown in FIGS. 17-18. This function enables the system to analyze and profile the specific color gamut of the CPM or other device after it has been properly calibrated, thus learning the profile of the CPM. This unique device color profile may then be used for creating a LUT that will match the CDM gamut to that of the CPM, thus teaching the CDM to perform like the CPM. It is also possible to analyze and profile the color gamut of the CDM or other display device. The profiles of the CPM and CDM, or other display devices may be compared. Using an appropriate similarity metric, this comparison may be quantified and communicated to the user.

Unlike “video wall” systems in which only the grey balance and white levels of all displays are calibrated together, this process ensures that the three dimensional color profiles of the CDM and CPM match.

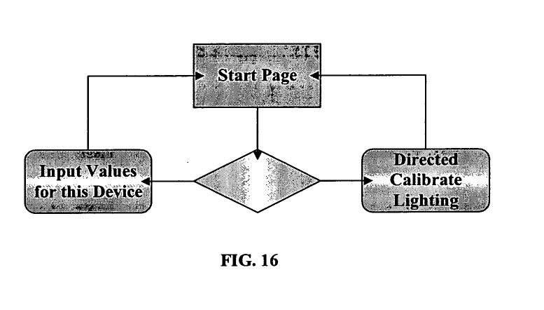

Specific calibration goals and methods for ambient lighting will now be described, and are shown in FIG. 16. The method involves sampling and displaying color temperature and intensity (footcandles) of incident room lighting.

A manual adjustment method for calibrating ambient lighting involves placing the sensor on the desktop or work surface with the sensor facing the overhead illumination source(s) in order to take incident light readings. Light level may be adjusted by selecting appropriately sized (wattage) bulbs and fine adjustments made with dimmers. Color temperature may be trimmed via lighting gels commonly used for such correction in photography. Fluorescent lights that operate at the desired D65 daylight color temperature with a sufficiently uniform/high CRI (color rendering index) may be used. Light output may be reduced as necessary with neutral density filters.

Ambient lighting calibration is done through a subset of the UI functions available for calibrating the CPM as shown in FIG. 9. The software provides a set of “ambient light” presets for this purpose. Optionally, these presets might also accommodate a secondary ambient lighting mode.

A dated verification log of calibration session results can be generated and printed.

The sensor may also be used as a simple light meter to directly read the color temperature and illumination level of other monochrome video monitors and lighting sources in the critical viewing environment. SMPTE RP 166 describes recommended light levels.

For measuring (direct reading) ambient lighting values the sensor may be placed directly on a work surface where light is to be measured with the sensor facing up and directly toward the overhead illumination source to operate as an incident light meter. The sensor is not used for reading light reflectance values from work surfaces.

Having now described an example embodiment, it should be apparent to those skilled in the art that the foregoing is merely illustrative and not limiting, having been presented by way of example only. Numerous modifications and other embodiments are within the scope of one of ordinary skill in the art and are contemplated as falling within the scope of the invention.

1. A method for display color calibration comprising:
sampling white and color values from the surface of a color display; and
verifying color gain and phase accuracy by comparing red, green and blue components of the sampled values.

2. A method to map color gamut performance of a first calibrated color display device to color gamut performance of a second color display device, comprising:
measuring the color gamut performance of the first calibrated color display device;
measuring the color gamut performance of the second color display device; and
generating a mapping using the measured color gamut performance from the first and second devices whereby the color performance of the first calibrated color device is replicated on the second color display device.

3. The method of claim 2, further comprising:
comparing the measured color gamut performance of the first calibrated color display device to the measured color gamut performance of the second calibrated color display device.

4. A system for calibration of color display devices, comprising:
a computer;
one or more displays connected to the computer;
one or more sensors connected to the one or more displays, whereby each sensor measures light from the display to which the sensor is connected;
calibration software executed on the computer that receives the measured light from the sensor and provides image information to be displayed on the one or more displays;
a video application executed on the computer that receives the image information from the calibration software and processes and displays the image information on the one or more displays being calibrated.
